(19) United States
(12) Patent Application Publication
(10) Pub. No.: US 2013/0014412 A1
(43) Pub. Date: Jan. 17, 2013

(54) Luggage Identification and Recognition System

(71) Applicant: Stuart Berman, Baltimore, MD (US)

(72) Inventor: Stuart Berman, Baltimore, MD (US)

(21) Appl. No.: 13/537,723

(22) Filed: Jun. 29, 2012

Related U.S. Application Data
(63) Continuation-in-part of application No. 13/182,561, filed on Jul. 14, 2011, now abandoned.

(51) Int. Cl. G09F 3/20

(52) U.S. Cl. 40/6

(57) ABSTRACT

The invention described herein is a travel luggage identification and recognition system, and methods for its use. The identification systems which are shown and described herein, comprise a combination of three of more sections or labels which include both graphic design aspects, functionality and identification portions which are intended to provide proof of ownership as well as identification and ease of recognition. The travel identifications system assists in the recognition and identification, demonstration of ownership of items such as luggage, bag, travel articles or items shipped on airplanes, trains, buses, cruise ships and other travel items. In addition, our tag or label offers the ability to show proof of ownership with an inside tag or decal that can adhere to the inside of any luggage/bag or travel article.

### CROSS-REFERENCE TO RELATED APPLICATION

This application is a continuation-in-part of U.S. patent application Ser. No. 13/182,561, filed Jul. 14, 2011, now pending. The entire disclosure of this prior US patent application is hereby incorporated by reference.

### FEDERALLY SPONSORED RESEARCH

Not applicable

### BACKGROUND OF INVENTION

### Field of Invention

The handing of luggage/bags/travel items and/or the like during their transportation on airplanes, trains, buses, cruise ships and/or the like can damage or destroy the personal identification tags often used on a particular piece of luggage/bag and/or the like. If this occurs, proof of ownership becomes more difficult once the article in question reaches the intended destination. Our luggage identification system offers an affixed label which provides proof of ownership to the outside, a distinct label which includes a graphic design or figure which is, also, intended to be affixed to the outside of the luggage or bag as well as an additional information label to be located inside of an luggage/bag/travel article and or the like.

Domestic and international travel continues to increase annually. Each year billions of dollars are spent by passenger carriers to sort, track and process passengers' bags. Yet, this is only part of the battle. Once the luggage arrives safely at its intended destination—be it an airport, bus station, train depot, or cruise ship terminal—the passenger must be able to quickly identify his or her own luggage from the myriad of look-alike suitcases and trunks which are being simultaneously processed. Each year millions of bags need to be picked up or claimed from among a large number of similar items. This is particularly true where the article in question is a “late arrival” and thus is not available for immediate claiming by the owner. Many of the luggage/bags have similar shapes, sizes, colors and makeup and look a like. Our distinctive graphic designs and additional proof or ownership can help distinguish travel bags, luggage and other travel articles from the many others which may be present. This can, also, assist in the identification, recognition, and recovery of any lost or misplaced bags. “Last year, more than 31 million bags—around 1.4% of all checked luggage—arrived late, industry officials say.—Wall Street Journal—Aug. 13, 2009”.

Most luggage tags currently available and in use are adapted to be fastened directly to a luggage handle via a strap or loop of some sort which is not only difficult to recognize from a distance but may be torn off or removed and lost from the bag or luggage during both normal and improper handling normally associated with travel.

Among techniques used to identify luggage are a 3-D polymer-based construction, as well as highly-reflective and durable Coast Guard-approved material. The 3-D polymer based construction limits the designs and flexibility of the product. The durable Coast Guard-approved material is a reflective material that can only be made into specific shapes and lacks the flexibility available from the use of other colors or other type of designs. There are the drawbacks with each of these approaches. In addition neither of these products offer the consumer the ability to label their bag and have any proof of ownership identification along with their designs. While these techniques offer some type of identification of ones luggage, they are limited as to the graphic options and fail to provide the personal identification option and proof of ownership which is provided by the instant invention.

Other luggage identification systems are described in U.S. Pat. Nos. 3,417,496 and 3,640,008 which make use of a spotting system of a flag or unique shapes or colors to be seen from a distance. Both of these systems are designed with an identification system that protrudes from the luggage and is some sort of mechanical device/system. In addition their only type of layout for spotting luggage is geometric shapes and colors.

U.S. Pat. No. 6,364,365 describes a luggage identification system of devices that included adhesive stickers, tape, firm plastic tags, flexible plastic label, business card carriers, tags, envelopes and cards with each one having distinctive patterns that can include color options to be affixed to luggage. The disadvantage to this system of identifying luggage is that there is no proof of ownership, the layout only has patterns or colors without creating any unique graphically designed image.

U.S. Pat. No. 7,600,787 is described as having a two part system for identifying luggage. The first part is an adhesive label with a unique pattern with a separate key fob for identification. The label is placed onto the bag while the owner carries the key fob to show proof of identification. The disadvantage to the key fob system is the key fob can be lost which negates the whole system. In addition the identification layouts are restricted to geometric shapes and color.

The ability to apply identification labels and a graphically designed images or logo to luggage/bags and or the like offer a number of potential advantages. One advantage is that the identification label can be applied directly to the bag for identification and the graphic design/logo may enhance the appeal and level of personalization to the luggage/bag and or the like. A traveler may collect our various graphic designs as well as any licensed graphics/logos we develop or select for use. Our specific material and graphic designs will differentiate our product from others.

Therefore, there exists a need to identify luggage from similar pieces encountered when traveling. It is an object of the present invention to provide an adaptable luggage identification system that addresses these needs.

It is another objective of the present invention to provide a luggage identification system that will deter theft and prevent accidental misappropriation by making individual luggage pieces easily distinguishable from all others and readily recognized in crowded environments.

It is yet another objective of the present invention to provide a luggage identification system that can be used on all types of luggage in all environments.

An additional object of the present invention is to provide methods for systematically identifying luggage that permits groups of people to distinguish their luggage from that of all other travelers' luggage and simultaneously identify each group member's individual luggage and/or contents therein.

It is another object of the present invention to provide a luggage identification system that assists visually impaired persons in locating and tracking luggage or other objects to which the identification system of the present invention are affixed.

These and other objectives are achieved by the present invention which provides a luggage identification and recognition system and methods for its use.

### SUMMARY

The essence of the inventions lies in the graphic designs which appears on at least of the portions or labels of the identification system and are intended for application to the external surface of the luggage, bag or travel article. One of the portions which include the graphic design also serves as a proof of ownership. The portion or label which serves as a proof of ownership would have a graphic design which is either a portion of the graphic design present on the decorative label or a graphic design which is similar or suggestive of the more move design present on the decorative label. Both of these portions are intended to be capable of being seen and easily identified from a distance. The system provides an ideal means by which the individual traveler can quickly and easily identify and easily distinguish his/her luggage, bag, or travel article from those of other individuals. In addition, the system of the present invention provides a means for a group of individuals, such as a travel group to distinguish the group's luggage from the luggage of other travelers. At the same time, while the system provides a graphic presentation which could be associated with the group of travelers, the numerical and alphabetic information on the second tag applied to each piece of luggage would also serve to distinguish the luggage of each individual from those of the rest of the group.

This invention relates to be being able to recognize, identify and demonstrate ownership of ones personal belongings. The graphic decal/identification labels can be easily apply or attach to luggage, bags, travel articles and/or the like. In addition the identification labels can be easily written on or pre-printed to show proof of ownership for each piece of luggage/bags/article and/or the like.

Our luggage identifier comprises a graphic design decal or label and an identification decals or label that can be directly applied to any surface of luggage/bag or the like. The luggage identifier (proof of ownership) can be place directly on the luggage/bag/article and/or the like; or the handle of the luggage/bag/article and/or the like. The main design decal can be placed anywhere on the luggage/bag/article and/or the like to assist in spotting the luggage/bag/article and/or the like. The inside identification tag can be placed inside the luggage/bag/article and/or the like as additional proof of ownership. The construction of the material allows for random personal placement on any luggage/bag and or the like. The label is constructed of a durable material capable of withstanding exposure to handling, natural elements or other activity that might remove or destroy other forms of luggage, bag or travel item identification and recognition systems. In addition, it is constructed of material which permits it to be attached to non-rigid surfaces and is crush proof since it is capable of flexing with the material it is adhered or attached to. The labels are applied or affixed to the luggage/bag/travel article using an adhesive lay present thereon. Thus, the labels can be affixed either temporarily or permanently to any luggage type or travel article. Since the label material is to be held in place using pressure sensitive adhesives and adheres directly to the surface of an object to get optimal adhesion, it may take a period of time ranging from 1 minute to a few hours after initial contact to reach maximum or optimum adhesion on to the surface to which it has been applied. Normally a period of 1 minute to 10 minutes will be sufficient. However, the time period will vary depending on the material which makes up the surface on which it is applied, the texture of the surface, the cleanliness of the surface as well as conditions at the time such as temperature, humidity and general weather conditions.

In addition, the identification system of the application includes a means for display in a retail setting or environment. For example, the system may include one or more holes in the top area of the system which permits the system to be hung in a retail or display environment. If there is a single hole, it would be centered near the top edge of the system. If more than one hole is provided, these would be spaced across the top portion of the system to provide a balanced and clearly visible presentation of the identification system to possible purchasers. The one or more holes would not a part of the removeable labels, but would be on or through the backing material. In this way the labels whole when removed for use would be complete without holes or punctures.

With or without the use of one or more punched hole and or holes at the top of the identification system, the design layout allows the product to, also, be displayed on a table, shelf or any flat surface in various layouts such as a fan, stack, individually, and accordion style. An additional option in the overall packaging of our system would permit the system to have means for the system to be displayed with out any packaging or alternatively have all the packaging as part of the product itself.

Other means for display are, also, a part of the present invention. For example, the identification system may be enclosed in a transparent envelope or similar container which could be hung or displaced in an appropriate or conventional manner in a retail environment. A transparent envelope or similar container, may include one or more holes for hanging the system in a display setting or may include a loop or clip design which would similarly permit the system to be hung in an appropriate manner to provide visibility and easy access for potential purchasers. This system would provide a visual presentation of the system, while at the same time offering protection to the system prior to purchase from marking or scuffing due to transportation or vandalism.

Another embodiment of the invention relates to a method and apparatus to assist in identifying and/or decorating articles. In particular, the embodiment relates to a method and apparatus to identify and decorate luggage/bags/trunks/articles or the like for the travel industry.

In addition we assist the traveler by providing a functional and decorative die cut graphic label designed for hand pressure application to a bag/luggage/travel bag and/or the like which has a uniquely functional value as well as decorative purposes for attaching directly to ones luggage tag, bag, tote, trunk, and or the like for identification and recognition purposes.

These and other objectives are achieved by the present invention which provides a luggage identification and recognition system and methods for its use.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing aspects and many of the attendant advantages of this invention will become more readily appreciated as the same becomes better understood by reference to the following detailed description, when taken in conjunction with the accompanying drawings, wherein:

FIG. 1 exemplifies the system of the present invention which includes the three part luggage label.

FIG. 2 exemplifies the identification system of the present invention which includes two sets of the identification system labels present on a single backing or support.

FIG. 3 exemplifies the identification system of the present invention and shows the labels wherein both the first portion label and second portion or label includes a colorful graphic design of the type intended to appear on the system of the invention.

### DETAILED DESCRIPTION

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing the subject components of the invention that are described in the publications, which components might be used in connection with the presently described invention.

The information provided below is not admitted to be prior art to the present invention, but is provided solely to assist the understanding of the reader. The details of one or more embodiments of the invention are set forth in the accompanying drawings and the description below. Other features, objects, and advantages of the invention will be apparent from the description and drawings, and from the claims.

The travel luggage identifications labels of the invention comprise at least three die cut labels present on an individual backing material or support. Each label is separately removable from the backing material and will have adhesive thereon which will permit placement of the label on the luggage, bag or travel article. The size of the die cut labels may be the same or different. The preferred system would include two labels which are of similar or substantially equal size and would provide space for information to provide identification and demonstrate ownership. The third portion, which includes the graphic design would be larger such that when attached to the luggage/bag/article would be recognizable and visible from a distance. The die cut material is printable and made to display various graphics, colors, logos, insignia's, letters, names, university names/logos, professional athletic teams names/logos, high school names/logos, museum's—works of art, museum name/logos, symbols, shapes, corporate names/logos, individual name, religious insignia, historic art/artifact or design, photographic imaging, branches of military, military insignia, military medals, country/state/territory flags and or country/state insignia's or other identifying graphics.

While the disclosure refers to the portions of the identification system as labels, the term is intended to be representative and equivalent to such terms of decal, tags, and attachments.

The three component label may also include computer readable information to assist in its use of automated data collection, tracking, and routing devices. Since the label system is designed to adhere directly to luggage/bags/travel article, and or the like it may also include information or indices which permits automated computer recognition and recording.

For hotels, resorts, travel agencies, cruise ships, bus companies, airlines our three component label can assist in the identification of ones' personal belongings when traveling. Our ability to print on our durable material offers corporations and individuals to opportunity to monitor their luggage/bags and or like through the use of automated data collection devices.

The travel luggage identification system shown herein comprises of a flat material which has a top printable surface and includes an adhesive on the back surface which is protected by a support or backing material. It may be made by applying an adhesive transfer tap which includes an adhesive and backing, such as those available from 3M. The resulting die cuts or labels are flexible, printable, and durable material for allowing a spotter/traveler to identify ones luggage/bag and or the like.

The base material of the travel decal luggage identifications unit comprises of a front face or surface, a rear face with modified acrylic adhesive known in the art to provide a very high-bond strength to many surfaces. A backing material that is removably attached or applied to the adhesive on the rear face of the label or system. The backing material or support may be paper, a polymer material or any material which will serve to cover the adhesive and yet be easily removable prior to application or use of the labeling system. The front face comprises of at least three different labels having distinctive graphics and functionality. One of which is to be applied to the inside of the bag or luggage or the like in the event all external distinguishing tags are lost, damaged or stolen. This portion of the label also provides an additional security feature as well.

The adhesive is selected to provide excellent chemical resistance and hold strength even at elevated temperatures. An example of suitable adhesive would be that used in Adhesive Transfer Tapes with 3M™ Adhesives that are a modified acrylic adhesive which are ideal for providing a very high-bond strength to many surfaces when the protective layer is removed and the label is applied directly to the exterior or interior of the luggage/bag and or the like.

The three component identification system of this invention can be prepared from any suitable material having the appropriate flexibility, durability and printability for this application. Such materials as paper, polymers, plastics and/or cloth can be used. The preferred material would be a polymeric material such as polyolefin. This material is available in the form of strips, rolls and sheets. It comes in the form of “soft” and “hard” types, both of which provide a fabric like support having good tear resistance, flexibility and printability. An example of a method for making our decorative labeling system includes the steps of (a) providing a material of fine fibers composed of 100 percent high-density polyethylene that are randomly distributed and nondirectional (trade name: Tvyek) which has a top printable surface and a bottom adhesive surface, (b) the material is cut to the appropriate size, (c) an adhesive or adhesive tape is applied to the rear side or the side designated as the back side, (d) a removable strip or cover, which may be paper or other suitable layer, is then applied to the adhesive and then the system is printed or imprinted with the described information or graphics to yield a system as herein described. The labels of this system are extremely simple to use, inexpensive and easy to apply and is in the nature of what is called a “premium article”. The preferred method of making the claimed three component label starts with 100% percent high-density flashspun, high density polyethylene that is described as being randomly distributed and non-directional. Such a product is available from Dupont and is sold under the trade name: Tvyek. Once the assembly of the material is complete our three component label is ready to go to print. The top layer of the material is designed to allow ink or other printable material to adhere to the top layer. The nature of the top material allows for detailed graphics printed in any graphic design layout as well as an color. Additional features of the material allow for the use over the counter pens and markers to write on the top layer of the material.

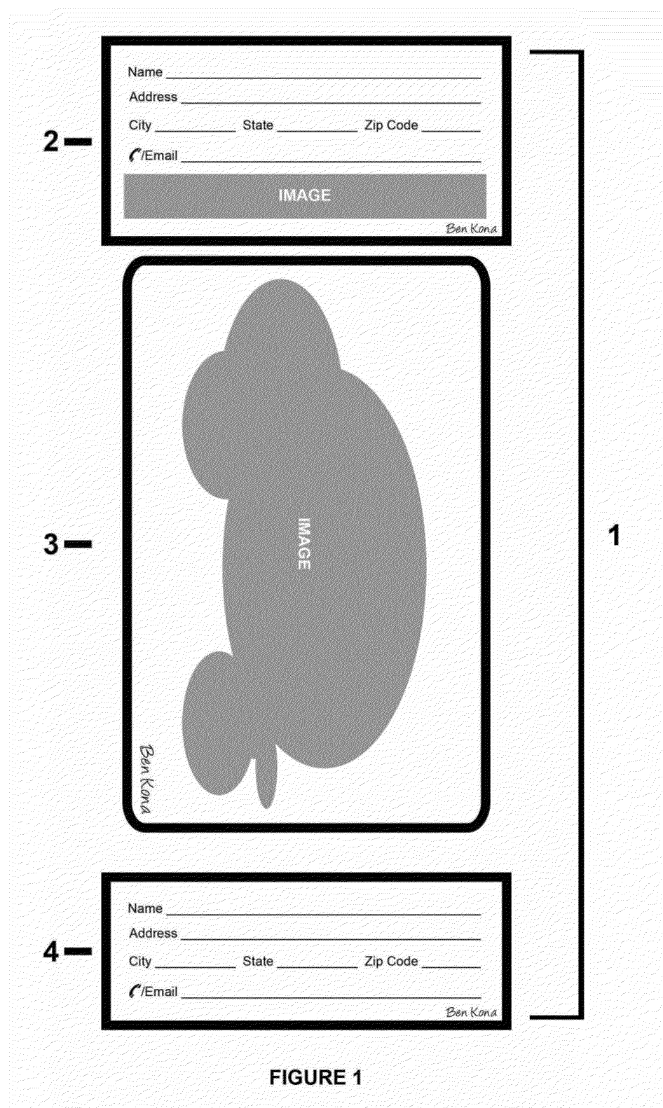

FIG. 1 shows the system of the present invention which exemplifies the three part luggage label (1). The first label or portion (2) is intended to include information for personal identification and includes at least a small decorative graphic design or a portion of a graphic design which would reasonably be associated or seen to correspond to the graphic design which appears on the second portion or label of the system. The second portion or label (3) shows a graphic design, is intended to be larger than the first portion or label, and provides a visual recognizable graphic which will be placed on the outside of the luggage, bag or article. The “image” may be any of the graphic designs or lettering described herein. The third portion or label (4) is intended to include written or pre-printed information and is intended to be placed or attached inside of the luggage, bag or article as an added level of security to show proof of ownership.

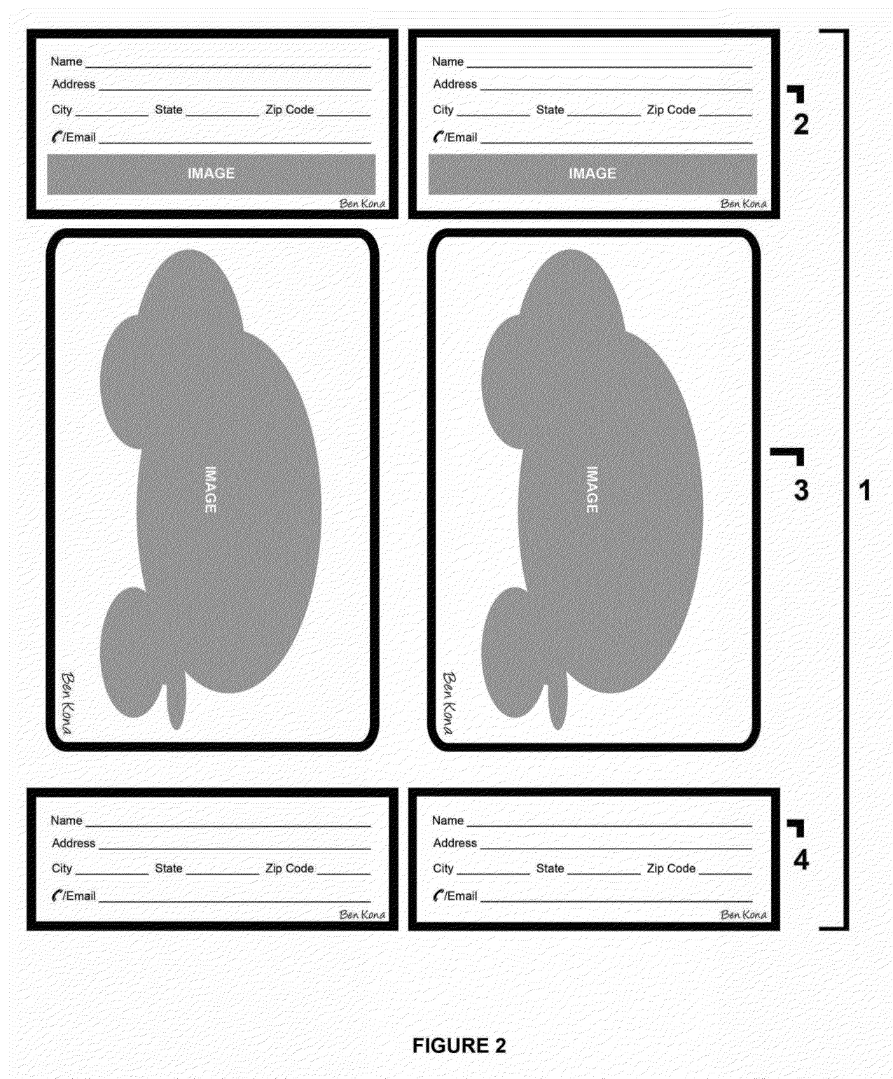

FIG. 2. shows the identification system of the present invention which exemplifies two sets of the identification system present on a single backing or support and would be presented as a single sheet including duplicates of the labels of FIG. 1.

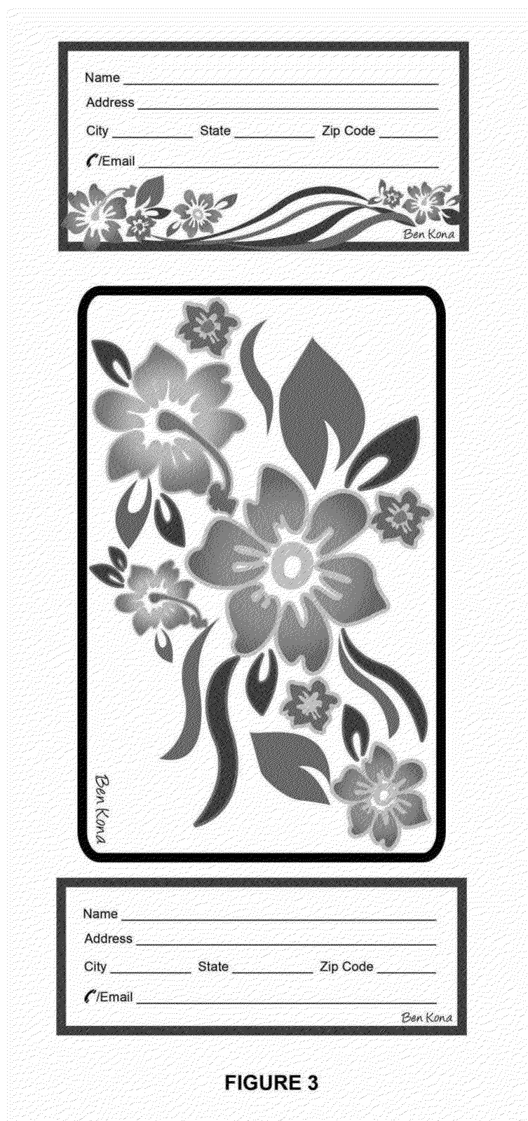

FIG. 3. shows the identification system (1) of the present invention and exemplifies the labels wherein both the first portion label (2) and second portion or label (3) includes a colorful graphic design of the type intended to appear on the system of the invention. The third portion (4) is intended to include written or pre-printed information and is intended to be placed or attached inside of the luggage, bag or article as an added level of security to show proof of ownership.

A specific die cut layout has been designed for the said material as seen in FIG. 1, FIG. 2 & FIG. 3. The printed graphic designs are then cut in a die cut machine and the said material is scored in a manner to allow for the removal of the top layer with the printed graphics along with the adhesive backing being removed from the paper backing and creating a label to adhere to luggage/bags and or a like.

The prior art documents mentioned herein are incorporated to the fullest extent permitted by law.

Unless otherwise defined, all technical and scientific terms used herein have the same meaning as commonly understood by one of ordinary skill in the art of molecular biology. Although methods and materials similar or equivalent to those described herein can be used in the practice or testing of the present invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and are not intended to be limiting.

Reference is made to standard textbooks and other references (e.g., journal articles) that contain definitions and methods and means for carrying out basic techniques, encompassed by the present invention.

### Equivalents

Those skilled in the art will recognize, or be able to ascertain using no more than routine experimentation, many equivalents to the specific embodiments of the invention described herein. Such equivalents are intended to be encompassed by the following claims.

What is claimed is:

1. A three part identification label system for luggage, bags, or travel articles, comprising: a first label having a front face with a visually recognizable distinctive image or design for application to the outside of the luggage, bag or article; a second separate label having a front face with at least a portion of an image or design which would be associated or seen to correspond to the distinctive image or design present on the first label and lettering or space for entry of personal or identification information which is representative of ownership and a third label having a front face to provide information and identification to provide proof of ownership to be placed on the inside of luggage/bag/travel article, wherein the second and third labels are of similar or substantially equal size and each provide space for information to provide identification and demonstrate ownership and the first label, which is larger than the other two labels, and which provides a visual recognizable graphic which will be placed on the outside of the luggage, bag or article and would be recognizable and visible from a distance; and wherein the whole label includes a rear face portion having an adhesive layer and a removable backing for removal prior to application and from which each label is separately removable for application the system additionally including means which permit display in a retail setting or environment.

2. The identification label system of claim 1 wherein the personal information and identification information is preprinted on either or both of the second and third labels.

3. The identification label system of claim 1, wherein the system includes means which permit display in a retail setting or environment and where that means is one or more holes in the top portion of the system.

4. The system of claim 3, wherein the system includes one hole in the top portion of the system.

5. The system of claim 3, wherein the system includes more than one hole in the top portion of the system.

6. The system of claim 1, where in the system includes means which permit display in a retail setting or environment and where that means is a transparent envelope or container which could be hung or displaced in an appropriate or conventional manner in a retail setting or environment.

7. The system of claim 6, wherein the transparent envelope or container includes one or more holes near the top which would permit the system to be displayed in a retail setting or environment.

8. A method of providing an identification and recognition means for luggage/bags/travel articles comprising separately applying a three part identification label system comprising a first label having a front face with a visually recognizable distinctive image or design for application to the outside of the luggage, bag or article, a second separate label having a front face with at least a portion of an image or design which would be associated or seen to correspond to the distinctive image or design present on the first label and lettering or space for entry of personal or identification information which is representative of ownership and a third label having a front face to provide information and identification to provide proof of ownership to be placed on the inside of luggage/bag/travel article, wherein the second and third labels are of similar or substantially equal size and each provide space for information to provide identification and demonstrate ownership and the first label, which is larger than the other two labels, and which provides a visual recognizable graphic which is placed on the outside of the luggage, bag or article and is recognizable and visible from a distance and the third label which is placed inside the luggage/bag/travel article to provide identification and demonstrate ownership should the other two labels be damaged or removed.
